(19) United States
(12) Patent Application Publication
(10) Pub. No.: US 2013/0198064 A1
(43) Pub. Date: Aug. 1, 2013

(54) Method and System for Administering Banking and Personal Savings Using a Mobile Computing Device

(71) Applicant: Thomas Joseph Sobut, Ontario (CA)

(72) Inventor: Thomas Joseph Sobut, Ontario (CA)

(73) Assignee: RIA Labs, Ontario (CA)

(21) Appl. No.: 13/823,246

(22) PCT Filed: Oct. 14, 2011
(86) PCT No.: PCT/CA11/50647

§ 371 Date: Mar. 14, 2013

Related U.S. Application Data
(60) Provisional application No. 61/394,402, filed on Oct. 19, 2010.

(51) Int. Cl. G06Q 40/02

(52) U.S. Cl. CPC G06Q 40/02
USPC 705/39

(57) ABSTRACT

A system and method enables a user to determine a financial benefit from making at least one small sacrifice if the monetary value of the at least one small sacrifice were to be saved in a destination account, or directed to make a particular investment or to reduce a particular debt. The method and system provides the user with a forecasted short-tem and/or long-tem outcome should the at least one small sacrifice be made. When the user chooses to apply the monetary equivalent of at least one small sacrifice to a destination account, the system can then facilitate a secure financial transaction with their bank's server. This transaction deducts the amount, or series of amounts, from the user's chosen source account, typically a checking account, and applies the savings amount to the user's chosen destination account, e.g., a mortgage account or a savings account.

### TECHNICAL FIELD

The present invention relates to banking applications and systems for computing devices, and in particular for mobile computing devices.

### BACKGROUND OF THE INVENTION

People who wish to save money, but who may have difficulty breaking wasteful spending habits may be prepared to forego small discretionary purchases, hereinafter referred to as “small sacrifices”, if appropriate tools were available for tracking and reporting them. These small sacrifices may encompass such things as buying a cup of coffee, making a meal instead of going out to a restaurant, washing the car at home instead of paying for a car wash, or not purchasing cigarettes. These small sacrifices take place over time, but are typically not tracked, and the benefits of their cumulative savings are not realized.

The term small sacrifice is not limited to random small monetary amounts. The following are examples that may be considered a small sacrifice: (i) foregoing the purchase of a new vehicle or expensive piece of jewellery; or (ii) setting up a regular transfer when the user succeeds in foregoing an ongoing or regular activity, such as smoking, or (iii) a monthly car lease payment on a foregone vehicle decision may also be considered a small sacrifice.

While many mobile banking applications exist, none facilitate the process of capturing, tracking, displaying and applying these small sacrifices as they happen, to then project the long-term benefit(s) of making a small sacrifice at given point in time, or in a series of sacrifices over time.

### SUMMARY OF INVENTION

The present invention seeks to provide a system and method that enables a user to determine a financial benefit from making at least one small sacrifice if the monetary value of the at least one small sacrifice were to be saved in a destination account, or directed to a particular investment or to reduce a particular debt. The method and system provides the user with a forecasted short-term and/or long-term outcome should the at least one small sacrifice be made. In particular, the system is able to take into consideration the interest rates and terms of the user's various financial accounts to project future outcomes. The rates and conditions for these financial accounts are user-configurable.

When the user chooses to apply the monetary equivalent of at least one small sacrifice to a destination account, the system can then facilitate a secure financial transaction with their bank's server. This transaction deducts the amount, or series of amounts, from the user's chosen source account, typically a checking account, and applies the savings amount to the user's chosen destination account, e.g., a mortgage account, a line of credit, or a savings account.

One advantage of the present invention is that the user receives instant gratification from a small sacrifice. They can also be motivated by the long-term effect of a series of sacrifices, such as in ending a smoking habit. They can view savings history and the cumulative effect of their savings plus the forecasted savings versus the benefits in near real-time. This immediate action-reward feedback loop motivates the user to save more, including discretionary amounts that are not related to a specific foregone purchase, but to a desire to top up or round up the value of a sacrifice, or to achieve a specific minimum prepayment on a structured debt such as a mortgage, or a structured savings plan, such as a monthly investment program. This feedback loop also motivates the user to stick to a regular program of savings, such as with the example of ending a smoking habit.

In a first aspect, the present invention provides a financial saving method for a user with a computing device, comprising steps: (a) based on user input, inputting a savings event into the computing device, whereby a savings event includes a monetary amount and that monetary amount corresponds to a monetary value for a purchase that the user is contemplating foregoing, and (b)

providing the user with at least one destination account option into which to transfer the monetary amount and displaying to the user at least one financial benefit to the user in making the transfer into the at least one destination account.

In a second aspect, the present invention provides financial saving system comprising: a computing device having: a user interface for inputting a savings event into the computing device, whereby a savings event includes a monetary amount and that monetary amount corresponds to a monetary value for a purchase that the user is contemplating foregoing, a processor for providing the user with at least one destination account option in which to transfer the monetary amount into, and a display means for displaying to the user at least one financial benefit to the user in making the transfer into the at least one destination account.

In a third aspect, the present invention provides a financial saving method for a user with a computing device, comprising steps:(a) based on user input, inputting a savings event into the computing device, whereby a savings event includes a monetary amount and that monetary amount corresponds to a monetary value for a purchase that the user is contemplating foregoing, and (b)

determining at least one potential financial benefit of the monetary amount being transferred to the at least one destination account and displaying the at least one financial benefit to the user.

### BRIEF DESCRIPTION OF THE DRAWINGS

The embodiments of the present invention will now be described by reference to the following figures, in which identical reference numerals in different figures indicate identical elements and in which:

FIG. 1 is a wireframe diagram of an exemplary user interface that shows the user the accumulated results of their total savings according to an embodiment of the present invention;

FIG. 2 is a wireframe diagram of an exemplary user interface that shows the user the accumulated results of their mortgage savings according to an embodiment of the present invention;

FIG. 3 is a wireframe diagram of an exemplary user interface that enables a user to enter a new savings event according to an embodiment of the present invention;

FIG. 4 is a wireframe diagram of an exemplary user interface that is used to configure the mortgage information in accordance with an embodiment of the present invention;

FIG. 5 is a wireframe diagram of an exemplary user interface that is used to configure the credit card information in accordance with an embodiment of the present invention;

FIG. 6 is a wireframe diagram of an exemplary user interface that is used to configure a retirement savings account in accordance with an embodiment of the present invention; and

FIG. 7 is a wireframe diagram of an exemplary user interface that is used to configure the account type in accordance with an embodiment of the present invention;

FIG. 8 is a system diagram in accordance with one embodiment of the present invention.

### DETAILED DESCRIPTION OF THE INVENTION

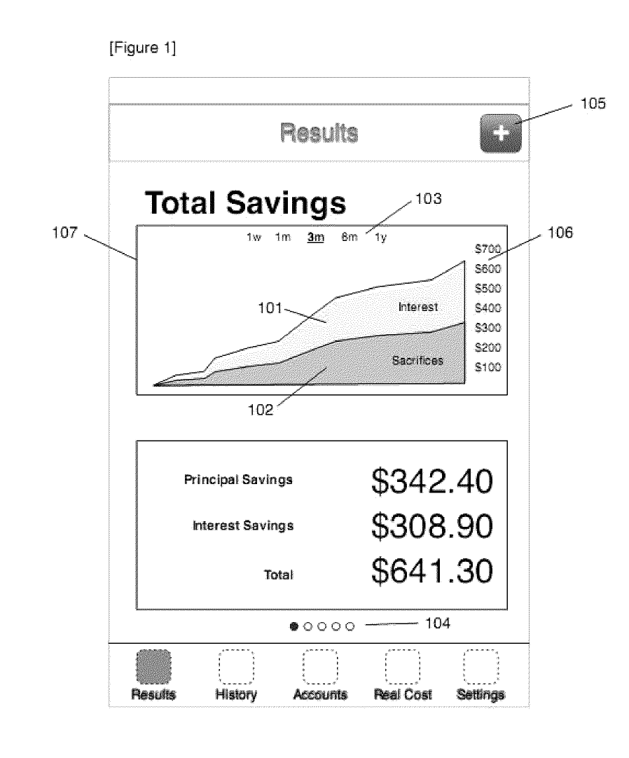

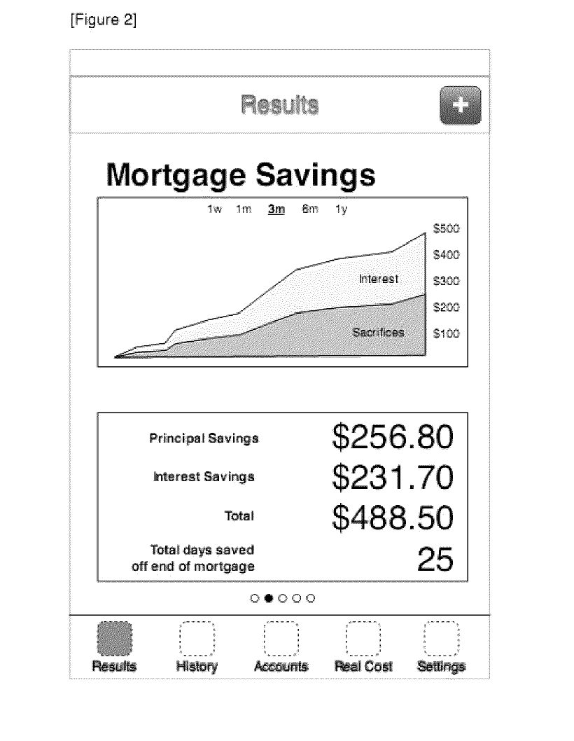

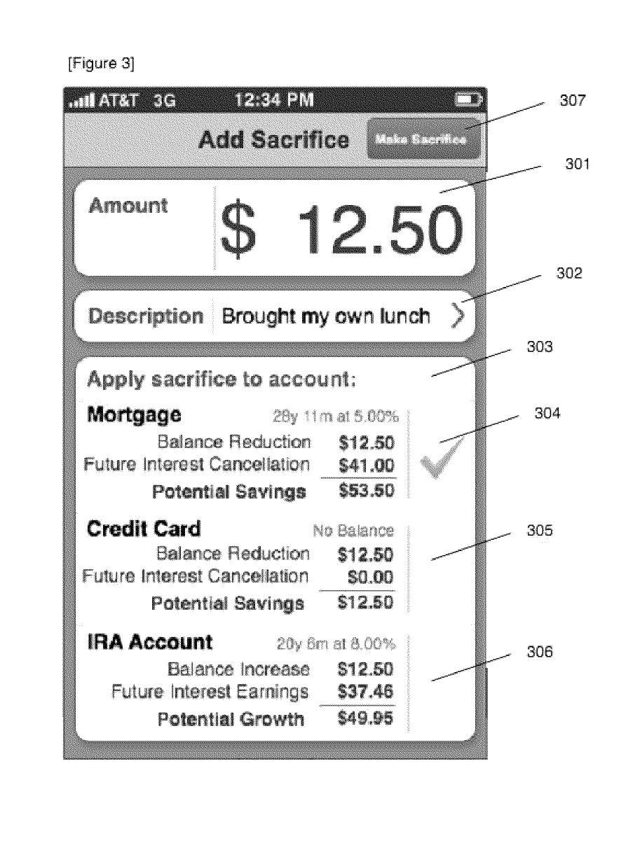

FIG. 1 is a wireframe diagram of an exemplary user interface that shows the user the accumulated results of their total savings resulting from the total of their small sacrifices, according to one embodiment of the present invention. The user interface (107) displays the total of small sacrifices made through the system over a period of time (103) as selected by the user. The graph (106) shows the total principal amount saved (102) and the total interest saved or earned (101). The small circular graphical icons (104) at the bottom indicate that there are further screens to display. User input by touch or otherwise will bring up detailed screens for the various destination accounts that the user may have previously configured. Refer to FIG. 2 for an example of a possible destination account, such as a mortgage account. Here, selecting button (105) enables a user to add a new sacrifice, which displays FIG. 3.

FIG. 2 is a wireframe diagram of an exemplary user interface that shows the user the accumulated results of their mortgage savings according to an embodiment of the present invention. Here, the user chose to transfer the monetary amount of his or her small sacrifices from a source account (not shown) to the user's mortgage account as the chosen destination account. Based on that decision, the system and method of the present invention has calculated various financial benefits of transferring the monetary amounts of those small sacrifices to the user's mortgage account. For this screen, the user chose to view a graph of financial benefits over a three month period of time, as shown by the “3 m” that is highlighted and underlined above the graph in FIG. 2.

In addition to the graph in FIG. 2, the financial benefits are displayed as a list of monetary amounts. In this case, the user has made a principal reduction of $256.80. Based on that principal reduction, the user has also made an interest savings of $231.70, i.e., the user has avoided that amount of interest by making those principal reductions. In sum, the small sacrifices made by that user in a three-month period have resulted in a combined current and future benefit of $488.50. In addition, the system and method of the present invention calculates and indicates to the user the reduction in required amortization of the mortgage. In this case, the user has reduced his or her mortgage amortization period by 25 days.

In FIG. 2, the financial benefits of the mortgage principal reductions have been displayed both graphically and numerically. However, either or both or some other display means, such as a pie chart, may be used to show the benefit a user has gained in making one or more small sacrifices.

It should be mentioned that the aim of the present invention is to show the user what short-term, and in particular what long-term, benefits may be realized in making a small sacrifice at a given point in time, or in a series over time. The aim is also to display at least one benefit in near real-time to provide a numerical incentive for the user to make the small sacrifice(s) that they are contemplating.

For further clarification regarding the present invention, it should be mentioned that initially the user may or may not have a savings goal in mind. Rather, the present invention enables the user to see the benefit of making a sacrifice. For example, the user's retirement savings account goes up by X percentage, or the user's credit card debt goes down Y dollars. In other words, the term benefit is a larger idea, while a goal can be subsumed within the term benefit. A goal is a benefit but a benefit is not necessarily, or cannot necessarily be turned into, a goal.

Furthermore, the present invention provides a means for determining a potential benefit of a savings event to determine a financial benefit. As an example, if X forgoes a $20 lunch, that $20 can be used towards any of the following pre-configured destination accounts:
(a) a registered retirement savings account (RRSP);
(b) reducing credit card A debt;
(c) reducing credit card B debt;
(d) reducing line of credit debt; and
(e) a specific account for saving towards a goal (e.g. a vacation).

Based on the above options, the present invention provides a forecast for each of the above destination accounts. As an example, the $20 savings towards the RRSP can be forecasted as growing to $Y when X retires in 30 years. Or, the $20 payment to credit card A or credit card B or line of credit debts is forecasted as saving $Z in interest for that month. For the goal, the $20 payment can be forecasted as moving C percent towards the end goal.

FIG. 3 is a wireframe diagram of an exemplary user interface that enables a user to enter a new savings event according to an embodiment of the present invention. The monetary amount is entered through a particular interface element (301). The item description is entered through another interface element (302). For these elements, the user may type in the appropriate amount and corresponding description. The amounts and descriptions may also be selected from a series of drop down menus with common descriptions or amounts that the user often selects. For example, the user may frequently decide to forgo a $2 coffee. As such, that amount and corresponding description would appear in the respective drop-down menus.

In FIG. 3, the bottom element (303) provides the user with a financial comparison between applying the amount to the various previously configured destination accounts. Here, the user has previously configured the following destinations accounts: a mortgage account (304), a credit card account (305), and a retirement savings account (306), also known as an RRSP account in Canada, or a 401K account in the U.S. Here, each account display shows the user the immediate and future financial benefits or savings achieved through this particular savings event. In particular, the user has decided to forego a purchased lunch, and bring a lunch from home instead, and put the monetary amount of $12.50 towards one of the three destination accounts.

In FIG. 3, the user has input a check mark next to the mortgage account to indicate that the monetary amount of $12.50 should be sent to that destination account. The user then records the savings events by selecting the “make sacrifice” input button (307).

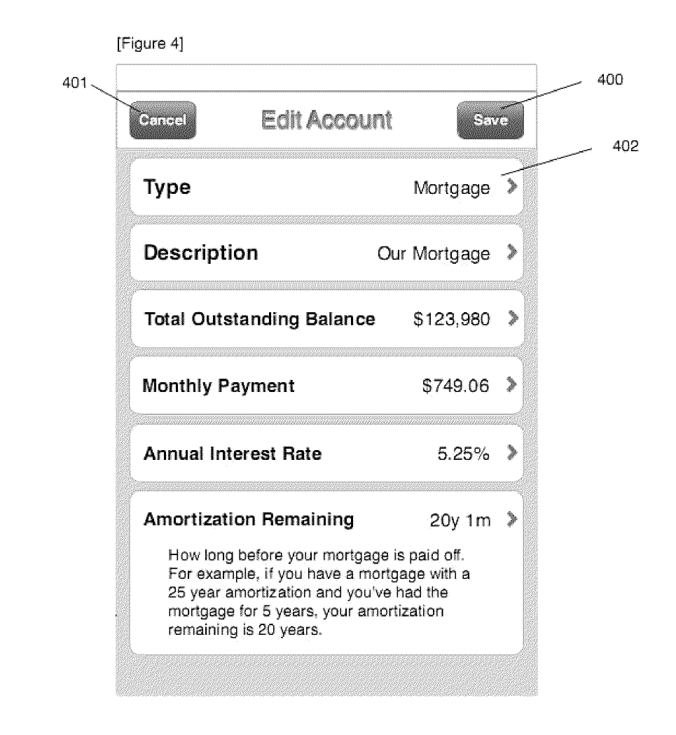

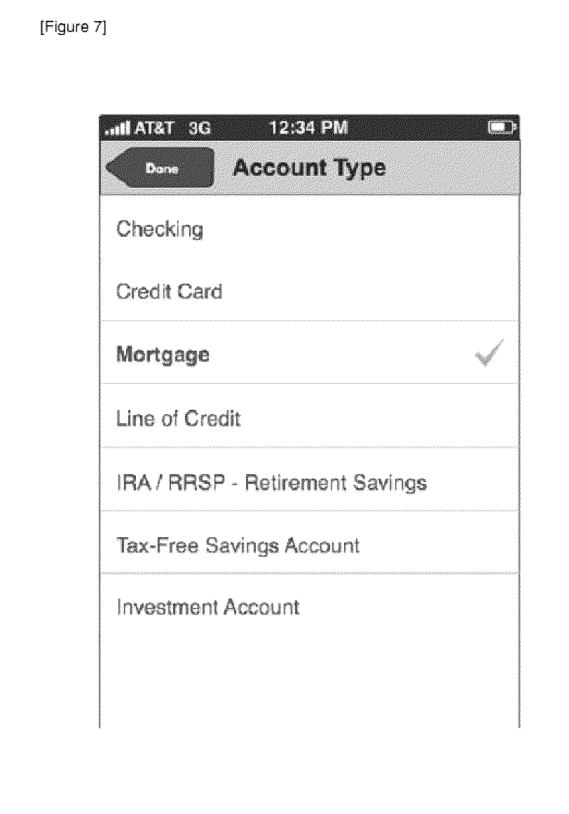

FIG. 4 is a wireframe diagram of an exemplary user interface that is used to configure a user's mortgage information in accordance with an embodiment of the present invention. The user is able to choose the value in the account type field (402), which will present a list of choices as in FIG. 7. The user is able to enter one or more mortgages as destination accounts using the save button (400) located at the top of the wireframe diagram. The user is also able to cancel any input made through the cancel button (401).

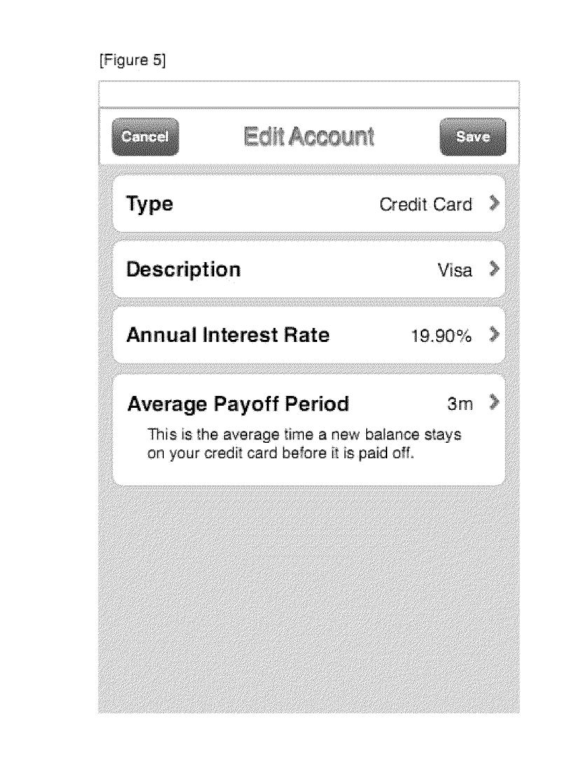

FIG. 5 is a wireframe diagram of an exemplary user interface that is used to configure the credit card information in accordance with an embodiment of the present invention.

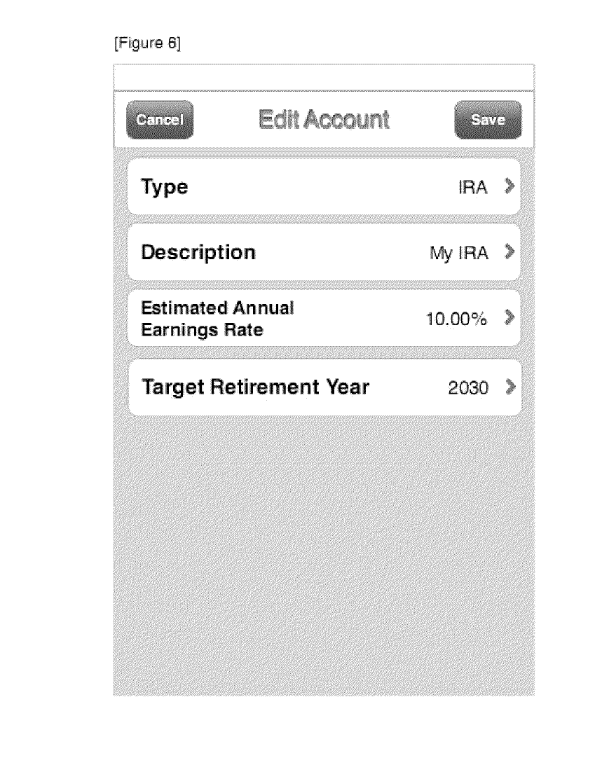

FIG. 6 is a wireframe diagram of an exemplary user interface that is used to configure a retirement savings account in accordance with an embodiment of the present invention.

FIG. 7 is a wireframe diagram of an exemplary user interface that is used to configure the account type in accordance with an embodiment of the present invention. This screen presents a list of choices in a menu form and the user chooses one from the list. Here, the following destination accounts are presented: a checking account, a credit card account, a mortgage account, a line of credit account, a retirement savings account, a tax-free savings account, and an investment account. The check mark next to the mortgage account indicates that the user has selected the mortgage account as the destination for the savings.

In addition, other types of destination accounts are contemplated, such as a donation account for a non-profit organization (NPO) or for a charitable organization. The present invention enables the user to see a financial benefit in giving to a charitable organization by his or her contribution. When the user chooses a destination Charity/NPO, the user interface will determine various benefits that their donation will make possible. For example, if a sacrifice were to be made to Charity A's Help Somalia Fund, X number of meals could be provided to the homeless or Y number of immunization shots for children.

It should be noted that the wireframe diagrams shown in FIGS. 1-7 are merely exemplary of the possible elements in the user interface. Many of these elements are interchangeable in terms of their location within the interface. For example, the graph (106) in FIG. 1 may be located below the numerical information. Alternatively, the graphical representations of the small sacrifices need not be provided. Rather the numerical information, such as the principal and interest savings, need only be displayed.

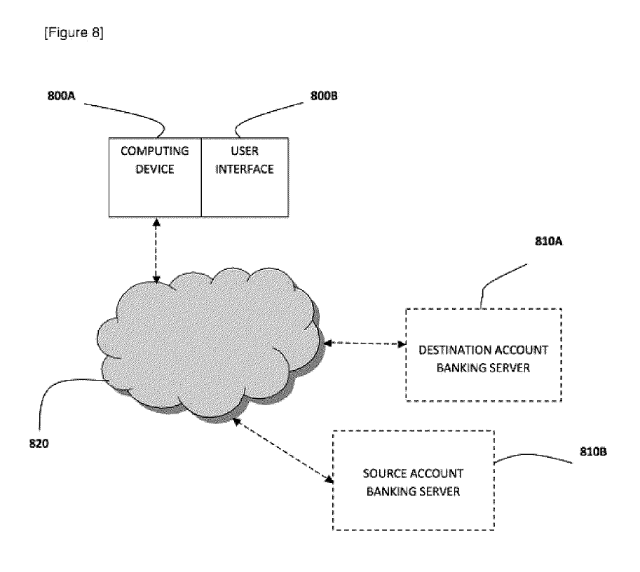

FIG. 8 is a system diagram of the present invention in which the system comprises a computing device (800A) that has a user interface (800B). In an alternative embodiment, the system also comprises at least one banking server (810A, 810B) that stores data relating to a source and destination accounts.

In FIG. 8, the computing device (800A) is able to communicate, through a communication channel (820), with the server (810). The server (810) may then transmit and receive data relating to the destination account. The server (810) can then make changes to the destination account and communicate those changes to the computing device (800A) The communication channel may be wireless or wired.

It is understood that the banking servers (810A, 810B) may represent a common server or represent a plurality of separate servers. For example, a user may transfer a monetary amount from a source account that is a checking account at one bank to a destination account that is a retirement savings account at another financial institution. Hence, one or more banking servers are contemplated and may be communicated with for the purposes of the present invention.

It should also be mentioned that the computing device may be any mobile, portable, or hand-held device. A person of skill in the art will understand that the present invention is not limited to a specific form factor. Therefore, the use of term “mobile” before computing device in this document is not meant to limit the scope of the present invention. The present invention may also be implemented on any computing device whether mobile or not. The term computing device encompasses desktops, tablet computers, mobile smartphones, notebooks, netbooks, and any computing device that is capable of accessing a network.

In FIG. 8, a mobile computing device may be contemplated as a computing device (800A), in which the mobile computing device has mobile communication capability to communicate wirelessly through the channel (820) with at least one banking server (810A, 810B).

The system and method of the present invention also contemplates functioning in a virtual mode if the user does not have an actual source account and destination configured. Users can store the data locally and transact the financial transactions manually at a later time.

In addition, it is recognized that the contact groups accessed by various forms of social media can be very powerful influencing factors in making social or personal finance decisions. As such, the present invention contemplates sending automated and/or semi-automated messages to contacts and/or contact groups in online social networks. The present invention further contemplates that these messages include direct comments to user's contacts informing them of one or more sacrifices made, the savings and/or potential savings achieved, and the user's personal objectives being met. Such messages, and the related responses received from contacts, can serve to reinforce the positive motivational effects created by the present invention.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g.“C”) or an object oriented language (e.g.“C++”). Alternative embodiments of the invention may be implemented as pre-programmed hardware elements, other related components, or as a combination of hardware and software components. Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

Having thus described the invention, what is claimed as new and secured by Letters Patent is:

1. A financial saving method for a user with a computing device, comprising steps:
(a) based on user input, inputting a savings event into the computing device, whereby a savings event includes a monetary amount and that monetary amount corresponds to a monetary value for a purchase that the user is contemplating foregoing, and
(b) providing the user with at least one destination account option into which to transfer the monetary amount and displaying to the user at least one financial benefit to the user in making the transfer into the at least one destination account.

2. The method as in claim 1, wherein a savings event is a predefined series of savings events.

3. The method as in claim 1, wherein the purchase is at least one purchase.

4. The method as in claim 1, further including step (c) of based on user input, communicating the savings event to a server that hosts the destination account to enable the transferring of the monetary amount of the savings event to one of the at least one destination account.

5. The method as in claim 1, further including the step of:
(c) based on user input, storing the savings event in memory for the user to enable the user to transfer the monetary amount of the savings event to one of the at least one destination account at a later time.

6. The method as in claim 1, wherein the at least one destination account is a group consisting of: a checking account, a credit card account, a mortgage account, a line of credit account, a retirement savings account, a tax-free savings account, an investment account, and a donation account.

7. The method as in claim 1, wherein step (c) includes storing in the computing device: (i) the savings event, (ii) information related to the transfer into the at least one destination account, and (iii) the at least one financial benefit.

8. The method as in claim 1, wherein step (d) includes communicating with a server that hosts the destination account to perform the transfer of the monetary amount.

9. The method as in claim 1, wherein step (e) includes sending a message for posting in an online social network.

10. The method as in claim 1, wherein the financial benefit is a long-term benefit.

11. A financial saving system comprising:
a computing device having:
a user interface for inputting a savings event into the computing device, whereby a savings event includes a monetary amount and that monetary amount corresponds to a monetary value for a purchase that the user is contemplating foregoing,
a processor for providing the user with at least one destination account option in which to transfer the monetary amount into, and
a display means for displaying to the user at least one financial benefit to the user in making the transfer into the at least one destination account.

12. The system as in claim 11, wherein the computing device includes communication means for communicating the savings event to a server that hosts the destination account and for enabling the transfer of the monetary amount of the savings event to one of the at least one destination account.

13. The system as in claim 11, wherein the computing device is a mobile computing device having mobile communication capability.

14. The system as in claim 11, wherein the computing device is a hand-held device.

15. The system as in claim 11, wherein the user interface is a graphical user interface.

16. The system as in claim 11, wherein the computing device is a touch screen computing device.

17. The system as in claim 11, wherein the computing device includes means for storing the savings event.

18. A financial saving method for a user with a computing device, comprising steps:
(a) based on user input, inputting a savings event into the computing device, whereby a savings event includes a monetary amount and that monetary amount corresponds to a monetary value for a purchase that the user is contemplating foregoing, and
(b) determining at least one potential financial benefit of the monetary amount being transferred to the at least one destination account and displaying the at least one financial benefit to the user.

19. The method as in claim 18, wherein the step (b) of determining the at least one potential financial benefit is a forecast calculated over a period of at least one month.

20. The method as in claim 18, wherein the at least one destination account is a group consisting of: a checking account, a credit card account, a mortgage account, a line of credit account, a retirement savings account, a tax-free savings account, an investment account, and a donation account.
